(19) United States
(12) Patent Application Publication
(10) Pub. No.: US 2011/0216078 A1
(43) Pub. Date: Sep. 8, 2011

(54) Method, System, and Apparatus for Processing Video and/or Graphics Data Using Multiple Processors Without Losing State Information

(76) Inventor: Paul Blinzer, Bellevue, WA (US)

(21) Appl. No.: 12/717,265

(22) Filed: Mar. 4, 2010

(51) Int. Cl. G06F 15/16

(52) U.S. Cl. 345/502

(57) ABSTRACT

Method, system, and apparatus provides for the processing of video and/or graphics data using a combination of first graphics processing circuitry and second graphics processing circuitry without losing state information while transferring the processing between the first and second graphics processing circuitry. The video and/or graphics data to be processed may be, for example, supplied by an application running on a processor such as host processor. In one example, an apparatus includes at least one GPU that includes a plurality of single instruction multiple data (SIMD) execution units. The GPU is operative to execute a native function code module. The apparatus also includes at least a second GPU that includes a plurality of SIMD execution units having a same programming model as the plurality of SIMD execution units on the first GPU. Furthermore, the first and second GPUs are operative to execute the same native function code module. The native code function module causes the first GPU to provide state information for the at least second GPU in response to a notification from a first processor, such as a host processor, that a transition from a current operational mode to a desired operational mode is desired (e.g., one GPU is stopped and the other GPU is started). The second GPU is operative to obtain the state information provided by the first GPU and use the state information via the same native function code module to continue processing where the first GPU left off. The first processor is operatively coupled to the at least first and at least second GPUs.

### FIELD OF THE INVENTION

The present disclosure relates to a method, system, and apparatus for processing video and/or graphics data using multiple processors and, more particularly, to processing video and/or graphics data using a combination of first graphics processing circuitry and second graphics processing circuitry.

### BACKGROUND OF THE INVENTION

In typical computer architectures, video and/or graphics data that is to be processed from an application running on a processor may be processed by either integrated graphics processing circuitry, discrete graphics processing circuitry, or some combination of integrated and discrete graphics processing circuitry. Integrated graphics processing circuitry is generally integrated into a bridge circuit connected to the host processor system bus, otherwise known as the “Northbridge.” Discrete graphics processing circuitry, on the other hand, is typically an external graphics processing unit connected to the Northbridge via an interconnect utilizing an interconnect standard such as AGP, PCI, PCI Express, or any other suitable standard. Generally, discrete graphics processing circuitry offers superior performance relative to integrated graphics processing circuitry, but also consumes more power. Thus, in order to optimize performance or minimize power consumption, it is known to switch video and/or graphics processing responsibilities between the integrated and discrete processing circuits.

FIG. 1, suggested prior art, generally depicts a computing system 100 capable of switching video and/or graphics processing responsibilities between integrated and discrete processing circuits. As shown, at least one host processor 102, such as a CPU or any other processing device, is connected to a Northbridge circuit 104 via a host processor system bus 106, and connected to system memory 122 via system bus 124. In some embodiments, there may be multiple host processors 102 as desired. Furthermore, in some embodiments, the system memory may connect to the Northbridge 104, rather than the host processor 102. The host processor 102 may include a plurality of out-of-order execution units 108, such as, for example, X86 execution units. Out-of-order architectures, such as the architecture implemented in the host processor 102, identify independent instructions that can be executed in parallel.

The host processor 102 is operative to execute various software programs including a software driver 110. The software driver 110 interfaces between the host processor 102 and both the integrated and discrete graphics processing units 112, 114. For example, the software driver 110 may receive information for drawing objects on a display 116, calculate certain basic parameters associated with the objects, and provide these parameters to the integrated and discrete graphics processing units 112, 114 for further processing.

The Northbridge 104 includes an integrated graphics processing unit 112 operative to process video and/or graphics data (e.g., render pixels) and is in connection with a display 116. An example of a known Northbridge circuit utilizing an integrated graphics processing unit is AMD's 780 series chipset sold by Advanced Micro Devices, Inc. The integrated GPU 112 includes a plurality of shader units 118. Each shader unit from the plurality of shader units 118 is a programmable shader responsible for performing a particular shading function, such as, for example, vertex shading, geometry shading, or pixel shading on the video and/or graphics data. The system memory 122 includes a frame buffer 120 associated with the integrated GPU 112. The frame-buffer 120 is an allocated amount of memory of the overall system memory 122 that stores data representing the color values for every pixel to be shown on the display 116 screen. In one embodiment, the host CPU 102 and the Northbridge 104 may be integrated on a single package/die 126. The Northbridge 104 is coupled to the Southbridge 128 over, for example, a proprietary bus 130. The Southbridge 128 is a bridge circuit that controls all of the computing system's 100 input/output functions.

The discrete GPU 114 is coupled to the Northbridge 104 (or the integrated package/die 126) over a suitable bus 132, such as, for example, a PCI Express Bus. The discrete GPU 114 includes a plurality of shader units 119 and is in connection with non-system memory 136. The non-system memory 136 (e.g., “video” or “local” memory) includes a frame buffer 121 associated with the discrete GPU 114 and is accessed via a different bus than the system bus 124. The non-system memory 136 may be on-chip or off-chip with respect to the discrete GPU 114. The frame buffer associated with the discrete GPU 121 has a similar architecture and operation as the frame buffer associated with the integrated GPU 120, but exists in an allocated amount of memory of the non-system memory 136. The shader units located on the discrete GPU 119 operate similarly to the shader units located on the integrated GPU 118 discussed above. However, in some embodiments, there are many more shader units 119 on the discrete GPU 114 than there are on the integrated GPU 112, which permits the discrete GPU 114 to process video and/or graphics data, for example, faster than the integrated GPU 112. One of ordinary skill in the art will recognize that structures and functionality presented as discrete components in this exemplary configuration may be implemented as a combined structure or component. Other variations, modifications, and additions are contemplated.

In operation, the computing system 100 may accomplish graphics data processing utilizing the integrated GPU 112, the discrete GPU 114, or some combination of both the integrated and discrete GPUs 112, 114. For example, in one embodiment (hereinafter “integrated operational mode”), the integrated GPU 112 may be utilized to accomplish all of the graphics data processing for the computing system 100. This embodiment minimizes power consumption by shutting the discrete GPU 114 off completely and relying on the less power-costly integrated GPU 112 to accomplish graphics data processing. In another embodiment (hereinafter “discrete operational mode”), the discrete GPU 114 may be utilized to accomplish all of the graphics data processing for the computing system 100. This embodiment boosts graphics processing performance over the integrated operational mode by relying solely on the much more powerful discrete GPU 114 to accomplish all of the graphics processing responsibilities. Finally, in one embodiment (hereinafter “collaborative operational mode”), both the integrated and discrete GPUs 112, 114 may be simultaneously utilized to accomplish graphics processing. This embodiment improves graphics data processing performance over the discrete operational mode by relying on both the integrated GPU 112 and the discrete GPU 114 to accomplish graphics processing responsibilities. Examples of commercial systems employing platform designs similar to computing system 100 include ATI Hybrid CrossFireX™ technology and ATI PowerXpress™ technology from Advanced Micro Devices, Inc., and Hybrid SLED technology from NVIDIA® Corporation.

However, existing computing systems employing designs similar to that depicted in computing system 100 suffer from a number of drawbacks. For example, these designs may cause a loss of state information when the computing system 100 transitions from one operational mode (e.g., integrated operational mode) to another (e.g., discrete operational mode). State information refers to any information used by, for example, the shader units, that controls how each shader unit processes a video and/or graphics data stream. For example, state information used by, for example, a pixel shader, could include pixel shader programs, pixel shader constants, render target information, graphical operations parameters, etc. Furthermore, state information includes identification information about a GPU, such as a GPU's physical address in the computing system's memory space and/or the model of GPU being utilized to process the video and/or graphics data.

When existing computing systems 100 transition from one operational mode to another, state information is often destroyed. Accordingly, existing computing systems 100 frequently require specific software support to re-create this state information in order for applications to operate correctly when video and/or graphics processing responsibilities switch between GPUs. This destruction and re-creation of state information unnecessarily seizes computing system processing resources and delays the switch from one operational mode to another. For example, it may take up to multiple seconds for existing computing systems 100 to switch from one operational mode (e.g., integrated operational mode) to another (e.g., discrete operational mode). This delay in switching between operational modes can also cause an undesirable flash on the display screen 116.

Existing computing systems 100 also fail to optimize graphics processing when configured in the collaborative operational mode. For example, within these computing systems, it is often necessary to restrict the processing capabilities of the more powerful discrete GPU 114 to the processing capabilities of the less powerful integrated GPU 112 in order to perform parallel graphics and/or video processing between both GPUs. This represents a “least common denominator” approach wherein the full processing capabilities of the discrete GPU 114 are severely underutilized.

Accordingly, there exists a need for an improved computing system capable of switching between integrated, discrete, and collaborative operational modes without losing state information and without a prolonged switching time. Furthermore, there exists a need for a computing system capable of maximizing the processing capability of the discrete GPU in a collaborative operational mode.

### BRIEF DESCRIPTION OF THE DRAWINGS

The invention will be more readily understood in view of the following description when accompanied by the below figures and wherein like reference numerals represent like elements, wherein:

FIG. 1 is a block diagram generally depicting an example of a conventional computing system including both integrated and discrete video and/or graphics processing circuitry.

FIG. 2 is a block diagram generally depicting a computing system in accordance with one example set forth in the present disclosure.

FIG. 3 is a block diagram generally depicting a general purpose execution unit in accordance with one example set forth in the present disclosure.

FIG. 4 is a flowchart illustrating one example of a method for processing video and/or graphics data in a computing system using multiple processors without losing state information.

FIG. 5 is a flowchart illustrating another example for a method for processing video and/or graphics data in a computing system using multiple processors without losing state information

### DETAILED DESCRIPTION OF THE PREFERRED EMBODIMENTS

Generally, the disclosed method, system, and apparatus provides for the processing of video and/or graphics data using a combination of first graphics processing circuitry and second graphics processing circuitry without losing state information while transferring the processing between the first and second graphics processing circuitry. The video and/or graphics data to be processed may be, for example, supplied by an application running on a processor such as host processor. In one example, an apparatus includes at least one GPU that includes a plurality of single instruction multiple data (SIMD) execution units. The GPU is operative to execute a native function code module. The apparatus also includes at least a second GPU that includes a plurality of SIMD execution units having a same programming model as the plurality of SIMD execution units on the first GPU. Furthermore, the first and second GPUs are operative to execute the same native function code module. The native code function module causes the first GPU to provide state information for the at least second GPU in response to a notification from a first processor, such as a host processor, that a transition from a current operational mode to a desired operational mode is desired (e.g., one GPU is stopped and the other GPU is started). The second GPU is operative to obtain the state information provided by the first GPU and use the state information via the same native function code module to continue processing where the first GPU left off.

In one example, the disclosed GPUs are vector processors in the form of single instruction multiple data (SIMD) processors, as opposed to scalar processors that employ extended instruction sets. The disclosed GPUs may include multiple SIMD engines and a general purpose SIMD register set that is used to store state information for the SIMD processor. The same instruction can be executed on the different SIMD engines as known in the art. The disclosed GPUs can be of the type of that execute C++ natively, as known in the art.

In another example, a computing system includes a processor such as one or more host CPUs coupled to the at least one GPU and the at least second GPU. In this example, there is a display operative to display pixels produced by either the at least one GPU, the at least second GPU, or both the at least one GPU and at least second GPUs simultaneously.

In another example, the native function code module associated with the at least second GPU is operative to optimize the number of pixels that can be rendered by the at least second GPU by distributing pixel rendering instructions evenly across the plurality of SIMD execution units on the at least second GPU. In another example, the native function code module associated with the at least one GPU is operative to optimize the number of pixels that can be rendered by the at least one GPU by distributing pixel rendering instructions evenly across the plurality of general purpose execution units on the at least one GPU.

In one example, the native function code module associated with the at least second GPU obtains state information from general purpose register sets in the plurality of SIMD execution units on the at least one GPU for execution on the plurality of SIMD execution units on the at least second GPU. In another example the native function code module associated with the at least one GPU obtains state information from general purpose register sets in the plurality of SIMD execution units on the at least second GPU for execution on the plurality of SIMD execution units on the at least one GPU. As used herein, obtaining state information may comprise retrieving the state information or having the state information provided.

In another example, the host processor is operative to execute a control driver to transition the computing system from an integrated operational mode to a discrete operational mode, and vice versa. In one example, the control driver asserts a processor interrupt (e.g., host CPU interrupt) to initiate a transition from the current operational mode to the desired operational mode, and vice versa. In yet another example, transitioning the computing system from a current operational mode to a desired operational mode includes transferring state information from general purpose register sets in the plurality of SIMD execution units on the GPU associated with the current operational mode to a location in memory that is accessible by the native function code module executing on the GPU associated with the desired operational mode.

The present disclosure also provides a method for processing video and/or graphics data using multiple processors in a computing system. In one example, the method includes halting the rendering of pixels by a first GPU associated with a current operational mode, and saving state information associated with the current operational mode in a location accessible by a second GPU. In this example, the method further includes resuming the rendering of pixels by at least a second GPU associated with a desired operational mode using the saved state information. In one example, the number of pixels that can be rendered in a particular operational mode is optimized by distributing pixel rendering instructions evenly across a plurality of general purpose execution units associated with a particular operational mode. In another example, the method includes determining that the computing system should be transitioned from a current operational mode to a desired operational mode. In another example, the state information is saved in general purpose register sets associated with the current operational mode in response to halting the rendering of pixels by a first GPU. In yet another example, the method also includes copying the saved state information from the general purpose register sets associated with the current operational mode to a memory location and subsequently obtaining that saved state information from that memory location. In another example, the determination that the computing system should be transitioned from a current operational mode to a desired operational mode is based on user input, computing power consumption requirements, and/or graphical performance requirements.

The present disclosure also provides a computer readable medium comprising executable instructions that when executed cause one or more processors to carry out the method of the present disclosure. In one example, the computer readable medium comprising executable instructions may be executed by an integrated fabrication system to produce the apparatus of the present disclosure.

The present disclosure also provides an integrated circuit including a graphics processing unit (GPU) operative to halt the rendering of pixels associated with a current operational mode. In this example, the GPU is also operative to save state information associated with the current operational mode in a location where it is accessible for use by a second GPU. In one example, the above-mentioned GPU is operative to resume the rendering of pixels previously being rendered by a second GPU, using state information saved by the second GPU, and in response to a transition from a current operational mode to a desired operational mode.

Among other advantages, the disclosed method, system, and apparatus provide for switching between integrated, discrete, and collaborative operational modes without losing state information and without a prolonged switching time. The disclosed method, system, and apparatus also mitigate the appearance of an undesirable flash on a display screen during an operational mode switch. Furthermore, the disclosed method, system, and apparatus maximize the processing capability of the discrete GPU in a collaborative operational mode. Other advantages will be recognized by those of ordinary skill in the art.

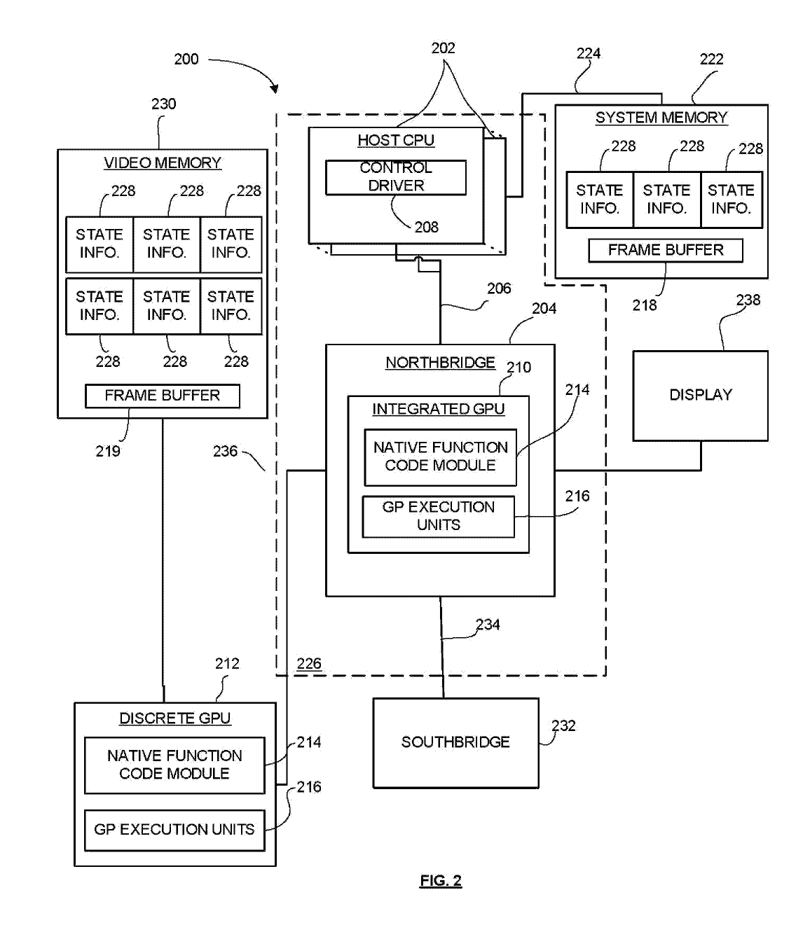

The following description of the embodiments is merely exemplary in nature and is in no way intended to limit the disclosure, its application, or uses. FIG. 2 illustrates one example of a computing system 200 such as, but not limited to, a computing system in a sever computer, a workstation, a desktop PC, a notebook PC, a personal digital assistant, a camera, a cellular telephone, or any other suitable image display system. Computing system 200 includes one or more processors 202 (e.g., shared, dedicated, or group of processors such as but not limited to microprocessors, DSPs, or central processing units). At least one processor 202 (e.g., the “host processor” or “host CPU”) is connected to a bridge circuit 204, which is typically a Northbridge, via a system bus 206. The host processor 202 is also connected to system memory 222 via system bus 224. The system memory 222 may be, for example, any combination of volatile/non-volatile memory components such as read-only memory (ROM), random access memory (RAM), electrically erasable programmable read-only memory (EE-PROM), or any other suitable digital storage medium. The system memory 222 is operative to store state information 228 and includes a frame buffer 218 associated with the GPU 210. The frame-buffer 218 is an allocated amount of memory of the overall system memory 222 that stores data representing the color values for every pixel to be shown on the display 238 screen. In one embodiment, the host processor 202 and the Northbridge 204 may be integrated on a single package/die 226.

The host processor 202 (e.g., an AMD 64 or X86 based processor) is operative to execute various software programs including a control driver 208. The control driver 208 interfaces between the host processor 202 and both the integrated and discrete graphics processing units 210, 212. As will be discussed in greater detail below, the control driver 208 is operative to signal a transition from one operational mode to another by, for example, asserting a host processor interrupt. The control driver 208 also distributes the video and/or graphics data that is to be processed from an application running on the host processor 202 to either a first GPU and/or a second GPU for further processing. By way of illustration only, an example of an integrated GPU and discrete GPU will be used, however the GPUs may be standalone chips, may be combined with other functionality, or may be in any suitable form as desired. FIG. 2 shows an integrated GPU 210 and a discrete GPU 212.

In this example, the Northbridge 204 includes an integrated graphics processing unit 210 configured to process video and/or graphics data, such as data received from an application running on the host processor 202, and is connected to a display 238. Processing video and/or graphics data may include, for example, rendering pixels for display on the display 238 screen. As known in the art, the display 238 may comprise an integral or external display such as a cathode-ray tube (CRT), liquid crystal display (LCD), light-emitting diode (LED) display, or any other suitable display. Regardless, the display 238 is operative to display pixels produced by the GPU 210, the discrete GPU 212, or both the integrated and discrete GPUs 210, 212. As will be further appreciated by one of ordinary skill in the art, the term “GPU” may comprise a graphics processing unit having one or more discrete or integrated cores (e.g., integrated on the same substrate as the host processor).

The GPU 210 includes a native function code module 214 and a plurality of general purpose execution units 216. The native function code module 214 is, for example, stored executable instruction data that is executed on the GPU 210 by the at least one of general purpose execution units 216 (e.g., a of the SIMD execution units). The native function code module 214 causes the execution unit 300 to dynamically leverage as many other general purpose execution units 216 as are available to carry out shading operations on the video and/or graphics data. The native function code module 214 causes the execution unit 300 to accomplish this functionality by analyzing the incoming workload (i.e., the video and/or graphics data to be processed resulting from, for example, an application running on the host processor 202), analyzing which general purpose execution units are available to process the incoming workload, and distributing the incoming workload among the available general purpose execution units. For example, when less than all of the general purpose execution units 216 are available for processing, the workload is distributed evenly across those general purpose execution units that are available for processing. Then, as additional general purpose execution units 216 become available (e.g., because they have finished processing a previously assigned workload), the execution unit 300 executing the native function code module 214 allocates the workload over the larger set of general purpose execution units so as to optimize the number of pixels that can be rendered by the GPU 210. Further, because the video and/or graphics data to be processed contains, among other things, pixel rendering instructions, the native function code module 214 optimizes the number of pixels that can be rendered by the GPU 210 (or, in another example, the discrete GPU 212) by distributing pixel rendering instructions evenly across the plurality of general purpose execution units 216 on the GPU 210 (or discrete GPU 212).

The general purpose execution units 216 are programmable execution units, having, in one embodiment, Single Instruction Multiple Data (SIMD) processors. These general purpose execution units 216 are operative to perform shading functions such as manipulating vertices and textures. Furthermore, the general purpose execution units 216 are operative to execute the native function code module 214. The general purpose execution units 216 also share a like register and programming model, such as, for example the AMD64 programming model. Accordingly, the general purpose execution units 216 are able to use the same instruction set language, such as, for example, C++. However, those having skill in the art will recognize that other suitable programming models and/or instruction set languages may be equally employed.

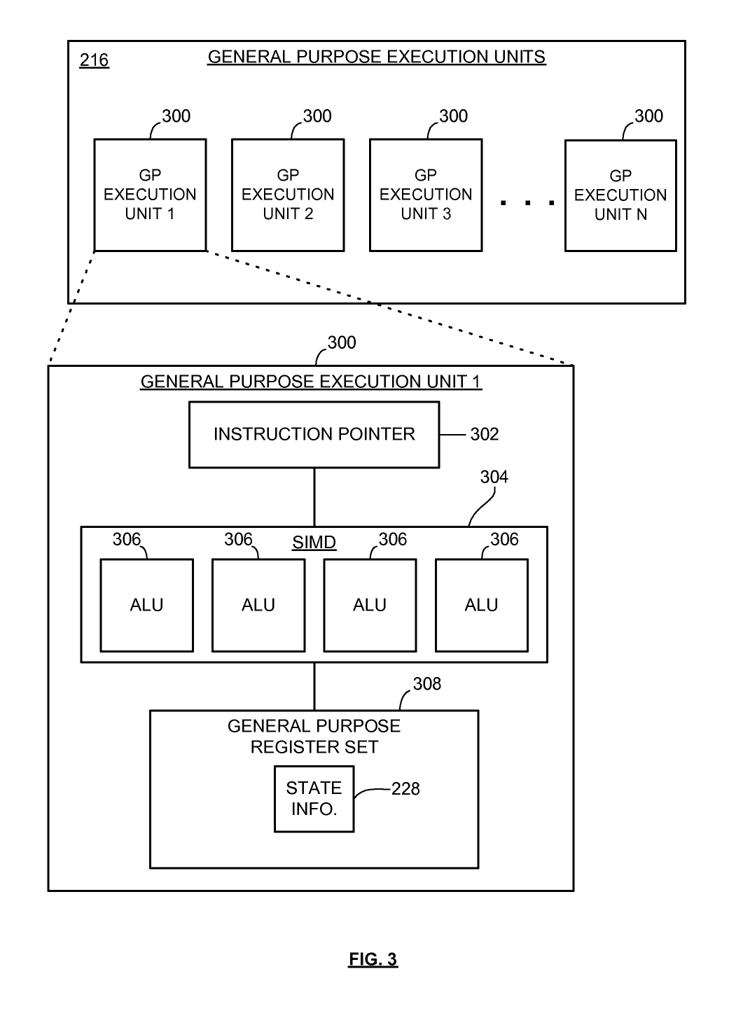

Referring now to FIG. 3, an exemplary depiction of a single general purpose execution unit 300 of the plurality of general purpose execution units 216 is provided. For example, FIG. 3 illustrates a detailed view of general purpose execution unit #1. General purpose execution units #s 2-N share the same architecture as general purpose execution unit #1, therefore, the detailed view of general purpose execution unit #1 applies equally to general purpose execution units #s 2-N. Furthermore, the plurality of general purpose execution units 216 may consist of as many individual general purpose execution units 300 as desired. However, in one embodiment, there will be fewer individual general purpose execution units 300 on the GPU 210 than there will be on the GPU 212. Nonetheless, the general purpose execution units 216 on the discrete GPU 212 will share the same register and programming model and instruction set language as the general purpose execution units 216 on the GPU 210, and are equally operative to execute the same native function code module 214.

Each general purpose execution unit 300 includes an instruction pointer 302 in communication with a SIMD engine 304. Each SIMD engine 304 is in communication with a general purpose register set 308. Each general purpose register set 308 is operative to store both data, such as, for example, state information 228, as well as addresses. State information may comprise, for example, the data values written out into, for example, a general purpose register set 308 following an instruction on the data. State information 228, for example, may refer to any information used by the general purpose execution units 216, that controls how each general purpose execution unit 300 processes a video and/or graphics data stream. For example, state information used by a general purpose execution unit 300 performing pixel shading could include pixel shader programs, pixel shader constants, render target information, graphical operations parameters, etc. Furthermore, state information 228 includes identification information about a GPU (e.g., the GPU 210 or the discrete GPU 212), such as a GPU's physical address in the computing system's memory space and/or the model of GPU being utilized to process the video and/or graphics data.

The SIMD engine 304 within each general purpose execution unit 300 includes a plurality of logic units, such as, for example, ALUs 306. Each ALU 306 is operative to perform various mathematical operations on the video and/or graphics data that it receives. The instruction pointer 302 is operative to identify a location in memory where state information 228 (e.g., an instruction to be performed on video and/or graphics data) is located so that the native function code module 214 can obtain the state information 228 and assign video and/or graphics processing responsibilities to the general purpose execution units 216 accordingly.

Referring back to FIG. 2, the Northbridge 204 (or in one embodiment, the integrated single package/die 226) is coupled to a Southbridge 232 over, for example, a proprietary bus 234. The Northbridge 204 is further coupled to the discrete GPU 212 over a suitable bus 236, such as, for example, a PCI Express Bus. The discrete GPU 212 includes the same native function code module 214 as the native function code module 214 on the GPU 210. Furthermore, the discrete GPU 212 includes general purpose execution units 216 sharing the same register and programming model (such as, for example, AMD64) and instruction set language (e.g., C++) as the general purpose execution units 216 on the GPU 210. However, as previously noted, in one embodiment there are far more individual general purpose execution units 300 on the discrete GPU 212 than are found on the GPU 210. Accordingly, in this embodiment, the discrete GPU 212 will process a workload much faster than the GPU 210 because the native function code module 214 can allocate the workload over a far greater number of individual general purpose execution units 300 on the discrete GPU 212. The discrete GPU 212 is further connected to non-system memory 230. The non-system memory 230 is operative to store state information 228, such as the state information 228 stored in system memory 222, and includes a frame buffer 219 that operates similarly to the frame buffer 218 described above. The non-system memory 230 may be, for example, any combination of volatile/non-volatile memory components such as read-only memory (ROM), random access memory (RAM), electrically erasable programmable read-only memory (EE-PROM), or any other suitable digital storage medium.

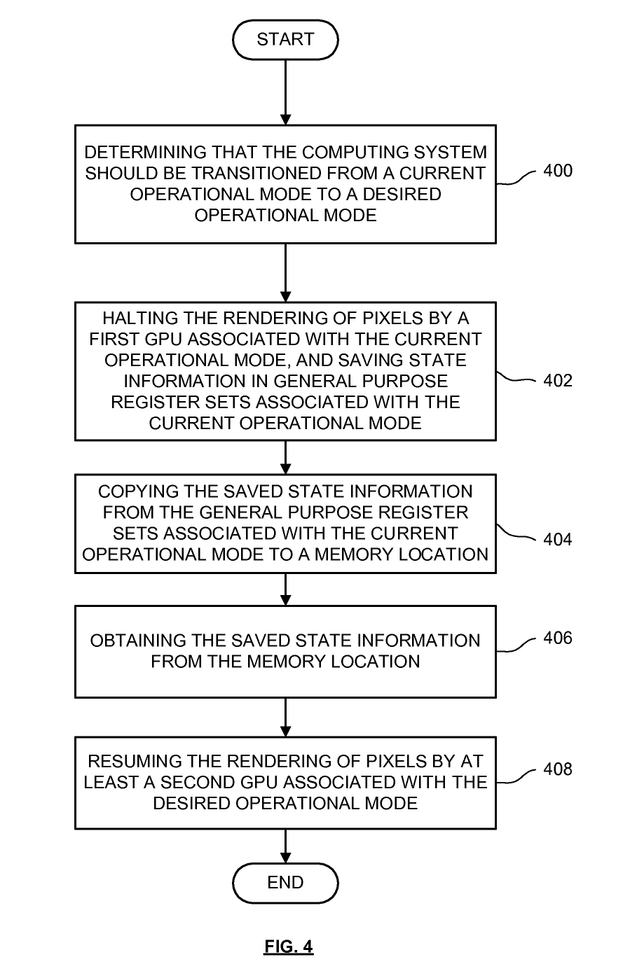

FIG. 4 illustrates one example of a method for processing video and/or graphics data using multiple processors without losing state information. At step 400, a determination is made that the computing system 200 should be transitioned from a current operational mode to a desired operational mode. This determination may be based on, for example, user input requesting a change of operational modes, computing system power consumption requirements, graphical performance requirements, or other suitable factors. In one example, the host processor 202, under control of the control driver 208, makes the determination. However this operation may be performed by any suitable component. The current operational mode and the desired operational mode may comprise, for example, an integrated operational mode, a discrete operational mode, or a collaborative operational mode.

At step 402, the rendering of pixels being accomplished by a first GPU associated with the current operational mode is halted and state information is saved in general purpose register sets associated with the current operational mode. As used herein, rendering may include, for example, processing video or generating pixels for display based on drawing commands from an application. The state information 228 may be saved, for example, in the general purpose register sets 308 in the plurality of general purpose execution units 216 on the first GPU associated with the current operational mode. The operation of step 402 may be further explained by way of the following example. If the current operational mode was the integrated operational mode (i.e., graphics processing was being accomplished solely on the GPU 210), state information 228 would be saved in the general purpose register sets 308 of the general purpose execution units 216 on the GPU 210. If the current operational mode was the discrete operational mode, state information 228 would be saved in the general purpose register sets 308 of the general purpose execution units 216 on the discrete GPU 212. Furthermore, the halting of the rendering of pixels by the GPU associated with the current operational mode may be initiated by the control driver 208 asserting an interrupt to the host processor 202. In this manner, the control driver 208 may be used to initiate a transition of the computing system 200 from one operational mode to another.

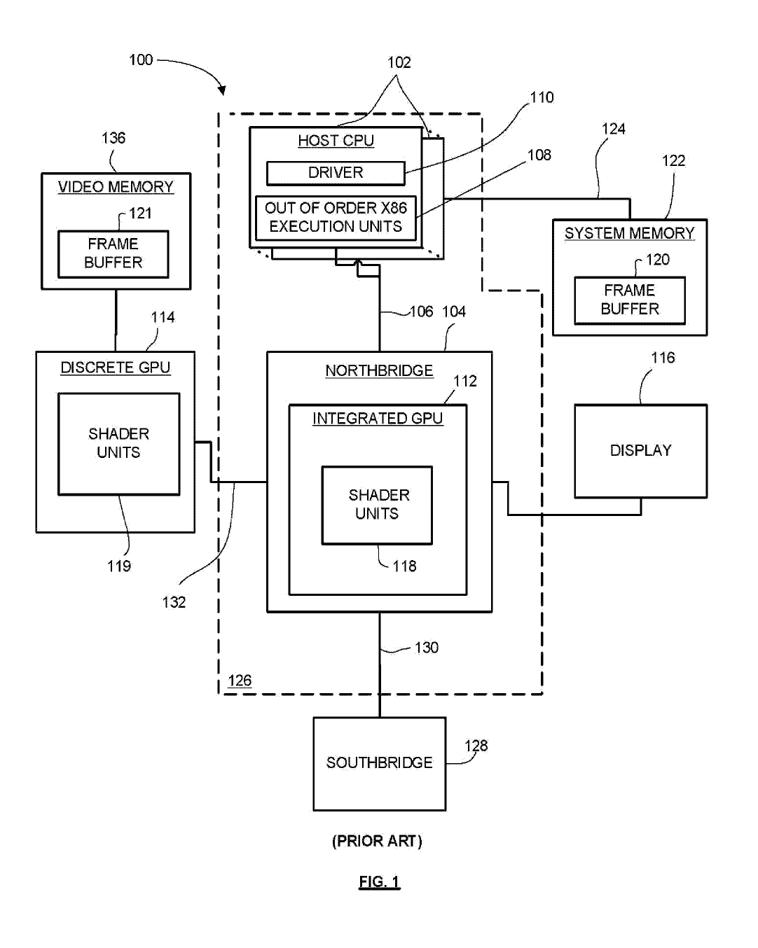

At step 404, the state information 228 saved in the general purpose register sets associated with the current operational mode is copied to a memory location. For example, when transitioning from an integrated operational mode to a discrete operational mode, the state information 228 would be copied from the general purpose register sets 308 of the general purpose execution units 216 on the GPU 210 to non-system memory 230. Conversely, when transitioning from a discrete operational mode to an integrated operational mode, the state information 228 would be copied from the general purpose register sets 308 of the general purpose execution units 216 on the GPU 212 to system memory 222. The host processor 202 is operative to perform the transfer (e.g., copying) of the state information 228 from general purpose register sets associated with the current operational mode to the memory. Transferring state information 228 in this fashion eliminates the need to destroy and re-create state information as was required by in conventional computing systems such as the computing system 100 depicted in FIG. 1. The general purpose register sets associated with the current operational mode correspond to the general purpose register sets of the desired operational mode in the sense that they share identical register set configurations (e.g. the registers are identical in both GPU sets).

At step 406, the saved state information 228 is obtained from the memory location. This may be accomplished, for example, by the native function code module 214 requesting or being provided with the state information 228 from either system memory 222 or non-system memory 230. For example, when transitioning from an integrated operational mode to a discrete operational mode, at step 406, the native function code module executing on the GPU 212 would obtain the state information 228 from non-system memory (which state information 228 was transferred from the general purpose register sets 308 of the general purpose execution units 216 on the GPU 210).

At step 408, the at least second GPU associated with the desired operational mode resumes the rendering of pixels. The at least second GPU associated with the desired operational mode will pick up the rendering of pixels exactly where the first GPU associated with the preceding operational mode left off. This essentially seamless transition is possible because the general purpose execution units 216 on both the discrete GPU 212 and the GPU 210 share the same register and programming model and instruction set language, and execute identical native function code modules 214.

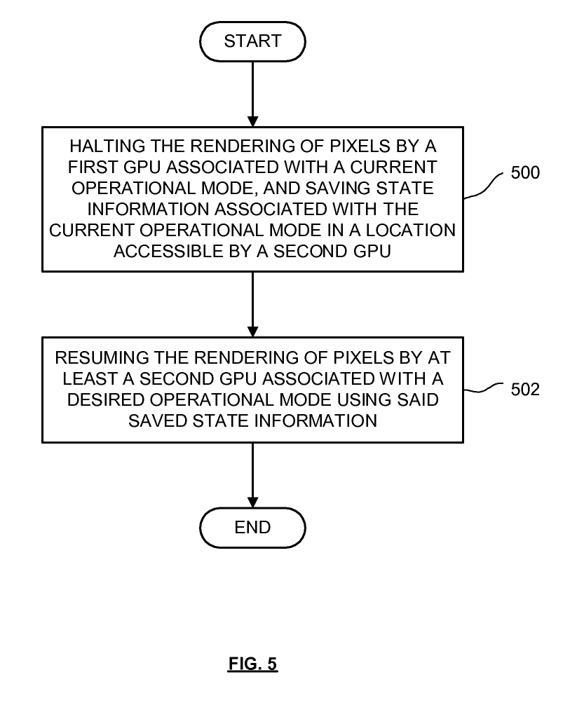

FIG. 5 illustrates another example of a method for processing video and/or graphics data using multiple processors in a computing system. In this example, state information is not saved in general purpose register sets. At step 500, the rendering of pixels by a first GPU associated with a current operational mode is halted and state information associated with the current operational mode is saved in a location accessible by a second GPU. In this example, the state information could be saved in any suitable memory, either on or off chip, including, but not limited to, dedicated register sets, system memory, non-system memory, frame buffer memory, etc. At step 502, the rendering of pixels is resumed by at least a second GPU associated with a desired operational mode using the saved state information.

Stated another way, in one example, a GPU (e.g., GPU 210) is operative to halt a rendering of pixels associated with a current operational mode, and save state information 228 associated with the current operational mode in a location accessible for use by a second GPU (e.g., discrete GPU 212). For example, in response to a transition from a current operational mode to a desired operational mode, the GPU (e.g., GPU 210) is operative to save state information in a location where it is accessible by another GPU (e.g., GPU 212) which is off-chip. This operation is also applicable from the perspective of, for example, the GPU 212.

Among other advantages, the disclosed method, system, and apparatus provide for switching between integrated, discrete, and collaborative operational modes without losing state information and without a prolonged switching time. The disclosed method, system, and apparatus also mitigate the appearance of an undesirable flash on a display screen during an operational mode switch. Furthermore, the disclosed method, system, and apparatus maximize the processing capability of the discrete GPU in a collaborative operational mode. Other advantages will be recognized by those of ordinary skill in the art.

Also, integrated circuit design systems (e.g. work stations) are known that create integrated circuits based on executable instructions stored on a computer readable memory such as but not limited to CDROM, RAM, other forms of ROM, hard drives, distributed memory etc. The instructions may be represented by any suitable language such as but not limited to hardware descriptor language or other suitable language. As such, the circuits described herein may also be produced as integrated circuits by such systems. For example an integrated circuit may be created using instructions stored on a computer readable medium that when executed cause the integrated circuit design system to create an integrated circuit that is operative to determine that a computing system should be transitioned from a current operational mode to a desired operational mode, halt the rendering of pixels by a first GPU associated with the current operational mode, and save state information in general purpose register sets associated with the current operational mode, and copy the saved state information from the general purpose register sets associated with the current operational mode to a memory location that is accessible by at least a second GPU associated with the desired operational mode. Integrated circuits having the logic that performs other of the operations described herein may also be suitably produced.

The above detailed description and the examples described therein have been presented for the purposes of illustration and description only and not by limitation. It is therefore contemplated that the present disclosure cover any and all modifications, variations or equivalents that fall within the spirit and scope of the basic underlying principles disclosed above and claimed herein.

What is claimed is:

1. A computing system comprising:
a first processor;
at least a first GPU, operatively coupled to the first processor, comprising a first plurality of single instruction multiple data (SIMD) execution units, the at least first GPU operative to execute a native function code module that causes the at least first GPU to provide state information for at least a second GPU in response to a notification from the first processor that a transition from a current operational mode to a desired operational mode is desired;
the at least second GPU, operatively coupled to the first processor, comprising a second plurality of single instruction multiple data (SIMD) execution units having a same programming model as the plurality of SIMD execution units on the at least first GPU, the at least second GPU operative to execute the same native function code module as the at least first GPU and operative to obtain the state information provided by the at least first GPU and use the state information via the same native function code module to continue processing.

2. The computing system of claim 1, wherein the native function code module associated with the at least second GPU is operative to optimize the number of pixels that can be rendered by the at least second GPU by distributing pixel rendering instructions evenly across the plurality of SIMD execution units on the at least second GPU.

3. The computing system of claim 1, wherein the native function code module associated with the at least first GPU is operative to optimize the number of pixels that can be rendered by the at least first GPU by distributing pixel rendering instructions evenly across the plurality of SIMD execution units on the at least first GPU.

4. The computing system of claim 1, wherein the native function code module associated with the at least second GPU obtains state information from general purpose register sets in the plurality of SIMD execution units on the at least first GPU for execution on the plurality of SIMD execution units on the at least second GPU.

5. The computing system of claim 1, wherein the native function code module associated with the at least first GPU obtains state information from general purpose register sets in the plurality of SIMD execution units on the at least second GPU for execution on the plurality of SIMD execution units on the at least first GPU.

6. The computing system of claim 1, wherein the host processor is operative to execute a control driver to transition the computing system from a current operational mode to a desired operational mode, and vice versa.

7. The computing system of claim 6, wherein the control driver asserts a processor interrupt to initiate a transition from the current operational mode to the desired operational mode, and vice versa.

8. The computing system of claim 6, wherein transitioning the computing system from a current operational mode to a desired operational mode comprises transferring state information:
from general purpose register sets in the plurality of SIMD execution units on the GPU associated with the current operational mode to a location in memory that is accessible by the native function code module executing on the GPU associated with the desired operational mode.

9. The computing system of claim 1, wherein the host processor and the at least first GPU are both embodied on at least one of:
a same chip package; or
a same die.

10. The computing system of claim 1, wherein each SIMD execution unit comprises:
an instruction pointer operative to point to a location in memory storing state information;
a SIMD engine comprising at least one ALU operative to execute state information retrieved from the location in memory; and
at least one general purpose register set operative to store state information.

11. The computing system of claim 1, further comprising at least one display operative to display pixels produced by either or both of the at least first or second GPU.

12. A method for processing video and/or graphics data using multiple processors in a computing system, the method comprising:
halting the rendering of pixels by a first GPU associated with a current operational mode, and saving state information associated with the current operational mode in a location accessible by a second GPU; and
resuming the rendering of pixels by at least a second GPU associated with a desired operational mode using said saved state information.

13. The method of claim 12 further comprising:
optimizing the number of pixels that can be rendered in a particular operational mode by distributing pixel rendering instructions evenly across a plurality of general purpose execution units associated with the particular operational mode.

14. The method of claim 12 further comprising:
determining that the computing system should be transitioned from a current operational mode to a desired operational mode.

15. The method of claim 12 wherein the state information is saved in general purpose register sets associated with the current operational mode in response to halting the rendering of pixels by a first GPU

16. The method of claim 15 further comprising:
copying the saved state information from the general purpose register sets associated with the current operational mode to a memory location; and
obtaining the saved state information from the memory location.

17. The method of claim 12, wherein the determination that the computing system should be transitioned from a current operational mode to a desired operation mode is based on at least one of:
user input;
computing system power consumption requirements; or
graphical performance requirements.

18. The method of claim 12, wherein the halting of the rendering of pixels by the GPU associated with the current operational mode is initiated by asserting an interrupt to a host processor.

19. An apparatus comprising:
at least a first GPU comprising a first plurality of general purpose execution units, the at least first GPU operative to execute a native function code module that causes the at least first GPU to provide state information for at least a second GPU; and
at least a second GPU comprising a second plurality of general purpose execution units having a same programming model as the plurality of general purpose execution units on the at least first GPU, the at least second GPU operative to execute the same native function code module as the at least first GPU and operative to obtain the state information provided by the at least first GPU and use the state information via the same native function code module to continue processing.

20. The apparatus of claim 19, further comprising a first processor operatively coupled to the at least first GPU and the a least second GPU, and wherein the first processor is operative to control copying of saved state information from general purpose register sets in the plurality of general purpose execution units associated with a current operational mode of either the at least first GPU or the at least second GPU to a memory location that is accessible by the native function code module executing on either the at least first GPU or the at least second GPU associated with the desired operational mode.

21. A computer readable medium comprising executable instructions that when executed cause one or more processors to:
determine that a computing system should be transitioned from a current operational mode to a desired operational mode;
halt the rendering of pixels by a first GPU associated with the current operational mode, and save state information in general purpose register sets associated with the current operational mode;
copy the saved state information from the general purpose register sets associated with the current operational mode to a memory location that is accessible by at least a second GPU associated with the desired operational mode.

22. A computer readable medium comprising executable instructions that when executed by an integrated circuit fabrication system, cause the integrated circuit fabrication system to produce:
at least a first GPU comprising a plurality of single instruction multiple data (SIMD) execution units, each operative to execute a native function code module; and
at least second GPU comprising a plurality of single instruction multiple data (SIMD) execution units having a same programming model as the plurality of SIMD execution units on at least first GPU, the at least second GPU operative to execute the same native function code module as the at least first GPU.

23. An integrated circuit comprising:
a graphics processing unit (GPU) operative to halt a rendering of pixels associated with a current operational mode, and save state information associated with the current operational mode in a location accessible for use by a second GPU.

24. The integrated circuit of claim 23 wherein the GPU is operative to resume rendering of pixels previously being rendered by a second GPU using state information saved by the second GPU in response to a transition from a current operational mode to a desired operational mode.
